(19) United States
(12) Patent Application Publication
(10) Pub. No.: US 2020/0372572 A1
(43) Pub. Date: Nov. 26, 2020

(54) SYSTEM, METHOD, AND COMPUTER READABLE STORAGE MEDIUM TO SCHEDULE LOAN TRANSFERS

(71) Applicant: Kabbage, Inc., Atlanta, GA (US)

(72) Inventors: Robert Frohwein, Atlanta, GA (US); Ranjeet Rawat, Bangalore (IN); Sushant Verma, Banagalore (IN); Ratnakar Pandey, Bangalore (IN)

(73) Assignee: Kabbage, Inc., Atlanta, GA (US)

(21) Appl. No.: 16/536,318

(22) Filed: Aug. 9, 2019

(30) Foreign Application Priority Data
May 22, 2019 (IN) 201941020246

(51) Int. Cl. G06Q 40/02; G06Q 20/10

(52) U.S. Cl. CPC G06Q 40/025; G06Q 20/108

(57) ABSTRACT

A method, system, and computer readable storage to enable a user to schedule and receive borrowed funds in the user's bank account. The date that the user can schedule the transfer of the funds can be any date into the future. The user can also set the system to provide for recurring such transfer of funds as well.

### BACKGROUND OF THE INVENTION

### Field of the Invention

The present general inventive concept is directed to a method, apparatus, and computer readable storage medium directed to scheduled loan transfers.

### Description of the Related Art

Loans/credit can be applied for and approved electronically. Credit card payments can be scheduled for automatic payments. For example, a user can schedule that a payment to his/her credit card can be made from his/her bank account on certain dates.

A user can also apply for and receive a loan electronically and the funds will be wired into the user's checking account. A drawback of this method is that the user may not need the funds yet, yet virtually all loans will charge interest to be paid to the lender based on how long the loan is outstanding.

### SUMMARY OF THE INVENTION

It is an aspect of the present invention to provide an improved loan system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of obtaining credit and scheduling credit disbursements, according to an embodiment;

FIG. 2A is a flowchart illustrating a method of scheduling a single credit disbursement, according to an embodiment;

FIG. 2B is a flowchart illustrating a method of scheduling a recurring loan transfer, according to an embodiment;

FIG. 3 is a flowchart illustrating a method of automatically processing scheduled loans, according to an embodiment;

FIG. 4 is a drawing illustrating an input window inputting a loan application from a user, according to an embodiment;

FIG. 5 is a drawing illustrating an input window displaying account information, according to an embodiment;

FIG. 6 is a drawing illustrating an input window initiated a scheduled loan including a recurring scheduled loan, according to an embodiment;

FIG. 7 is a network drawing illustrating components on the computer communications network, according to an embodiment; and

FIG. 8 is a block diagram illustrating an example of computer hardware which can be used to implement any computer utilized herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Applying for and obtaining credit is described in U.S. Pat. No. 7,983,951, which is incorporated by reference herein in its entirety. The general inventive concept described herein relates to an ability of a user (borrower), once he/she has obtained a line of credit, to be able to schedule a transfer of that credit at any time. A transfer of funds/credit would comprise borrowing a cash amount against the line of credit, and then transferring that cash amount into the user's bank account. The user can then utilize that cash amount for any purpose the user wishes. The user can schedule the transfer at a particular time or recurring time (e.g., monthly, weekly, etc.) In this manner, a user can pragmatically utilize her/her credit line and avoid being delinquent on other obligations, bank charges, etc. The lender would charge interest (e.g., 1% to 10% or other amount annually) which is computed based on a number of days a loaned amount is outstanding (owed by the user to the lender). It can be appreciated that a user having the ability to schedule loans transfers (from a lender paid into the user's bank account) on a day in the future (when the user really needs to utilize the funds) the amount of interest due to the lender can be reduced (compared to receiving the loon sooner when the user does not yet need the funds). While the word “loan” is used herein, this can also refer to any other transfer of money with repayment expected, such as a personal loan, business loan, merchant cash advance, etc.

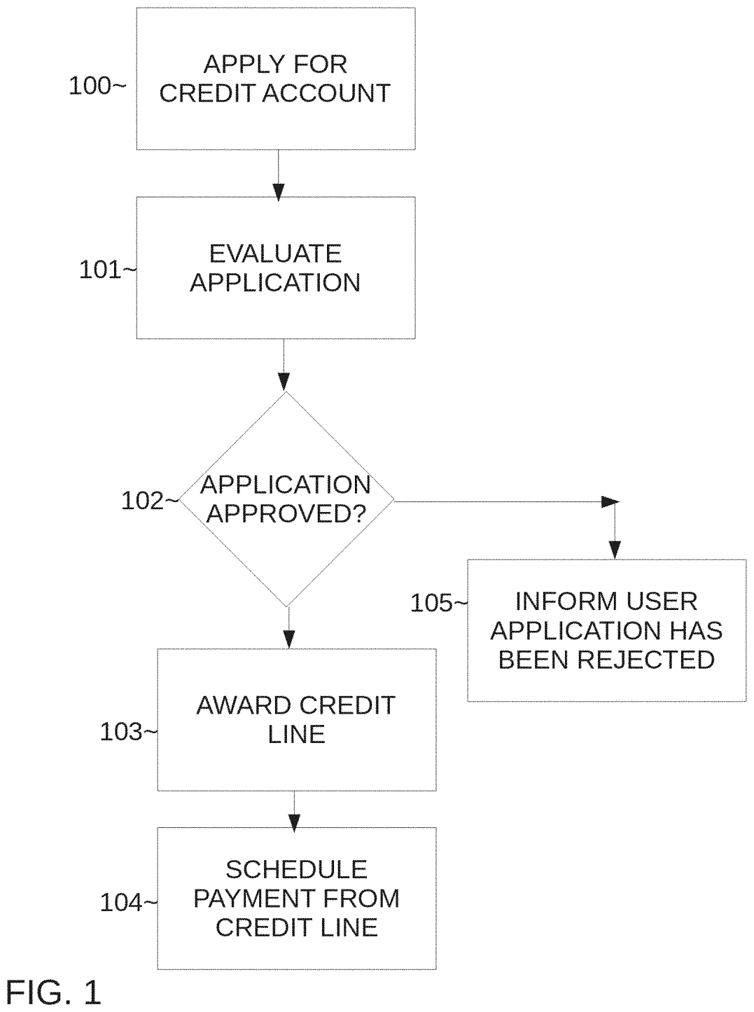

FIG. 1 is a flowchart illustrating an exemplary method of obtaining credit and scheduling credit disbursements, according to an embodiment. All of the operations in FIG. 1 (and the other flowcharts as well) can be performed by one or more electronic processors (which can be part of a server, database, computer, etc.)

The method can begin with operation 100, in which the user applies for a credit account. This can be done by the user logging on a web site (or opening an app on his/her phone, etc.) and providing application information by filling in forms. For example, the user may be asked for his yearly income, login information (username and password) for e-commerce platforms (e.g., EBAY), login information (username and password) for their financial accounts (e.g., their bank accounts, etc.) physical home address, email address, occupation, physical business address, gross business income. Any information that a lender would find helpful in evaluating an application can be asked an inputted from the user.

From operation 100, the method proceeds to operation 101, in which the processor evaluates the application from operation. 100. The application is evaluated automatically and can be run through a scoring system. For example, the user (credit applicant) would get a score based on their income, credit score (from one of the main credit bureaus (such as EQUIFAX, etc.), sales volume (e.g., on an e-commerce site such as EBAY), etc. Each factor can be given its own weight and a composite score can be a composite of all of the factors. The higher the composite score the better for the user. If the user's composite score reaches a predefined threshold, then the user would be approved for the credit line. There can be numerous other ways the user's application can be evaluated. The amount of the credit line can also be determined from the composite score (the higher the score, the higher the amount of credit the user is offered in the credit line).

From operation 101, the method proceeds to operation 102, which determines whether the credit line application has been approved. If so, then the method proceeds to operation 103. If not, then the method proceeds to operation 105 in which the user is notified (typically via email, web page message, or other type of message) that the application has not been approved and the method ends.

If in operation 103, the application for the credit line has been approved, then the method proceeds to operation 103, which awards the credit line to the user. The user may already have an account with the lender (party who is offering the credit line) but if not then an account will be created. The amount of the credit line (determined in operation 101) will then be displayed/reflected in the user/s account. For example, if the user was awarded a $10,000 credit line, then the user's account will have a field which displays that the user has a $10,000 credit line. It will also display how much of the credit is being utilized and how much credit is remaining.

From operation 103, the method proceeds to operation 104, which allows the user to schedule a loan transfer from the credit line into the user's bank account (e.g., his/her checking account). Note that there are other ways funds can be transferred to the user, e.g., via the user's PAYPAL account, into the user's savings account, etc. In other words, funds from the credit line do not have to be utilized contemporaneously with the user's using his/her account, but the utilizing of the credit line can be scheduled for a later time. For example, the user can enter than on a particular date in the future (e.g., Mar. 15, 2019), $1,000 will be deducted from the user's credit line and automatically (electronically) transferred into the user's bank account (which was entered during the application process in operation 100 unless the bank account information was already known to the system). The $1,000 transfer will be initiated by the system automatically (on the scheduled date) and the $1,000 would typically appear in the user's bank account quickly (e.g., immediately, an hour, 1 to 10 hours, within 24 hours, two business days, etc.) For example, if the user has a $10,000 credit line, and the user utilizes $1,000 of that credit line, then the user will have $9,000 remaining on his/her credit line and would owe the $1,000 (plus interest and lending fees) to the lender for the privilege of receiving the loan/credit. Note that once a loan is scheduled, the user at any time can modify the scheduled date(s), either to correct an error made by the user or just change the schedule as to meet the user's new preferences or situation.

The lender will charge interest to the user or all credit that is utilized. Once a credit amount outstanding is paid back, then the user will no longer pay interest (since there is no outstanding credit amount) but of course the user is obligated to pay any amount owed to the lender (e.g., interest, lending fees, etc.) for past credit utilization if this has not already been paid in full by the user.

In another embodiment, instead of a transfer (utilization) from the credit line being automatically transferred to the user's bank account, the transfer from the credit line will be paid directly to a creditor of the user (e.g., a mortgage payment, car payment, etc.) In this manner, the user can schedule transfers from his/her credit line to directly be paid to his/her creditors (instead of the transfer from the credit line being transferred to the user's bank account upon which the funds would then have to be transferred to the user's creditor he/she wishes to pay).

One advantage of the user scheduling a loan in this manner is that the user can save on interest. For example, instead of the user tapping into his/her credit line on one day where the user may not need the money yet, the user can now schedule the receipt of funds from his/her credit line on a date that the user will actually need the funds (e.g., to pay rent, etc.) Once the funds are received, the user can then write a check from the same account to pay a bill (e.g., rent, etc.) The advantage of this system is that the user will save on interest since the loan amount is only provided at the time the user needs it (and not earlier), thereby saving interest charges for the user.

Once the user has successfully received a credit line, this does not mean the user has actually received any funds until the user taps into the credit line (receives funds from it). The credit line can be tapped into at any time the user wishes, or the user can schedule a utilization (scheduled loan transfer) for a later time or later condition.

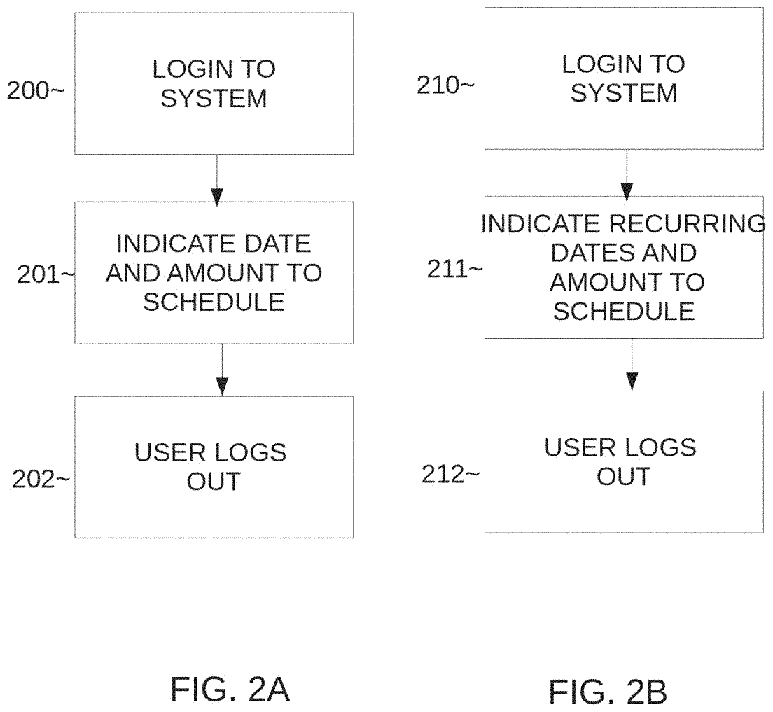

FIG. 2A is a flowchart illustrating a method of scheduling a single credit disbursement, according to an embodiment.

In operation 200, the user would login to the system (lender application). This can be done as known in the art, such as using a web browser, visiting the specific URL and typing in the username/password, or running an app (e.g., on a mobile device, etc.) Once logged in, the user can then view his/her account information, including their credit line, how much is currently utilized, how much is currently owed to the lender (which would be the amount of the credit line utilized (borrowed) plus any interest and lending fees due). Note that the lending fee can vary, and can be at least a minimum fee. For example, in an embodiment, even if the user pays the loan off quickly (e.g., in one day), the fee charged will be still be computed as if the user borrowed the funds for at least a minimum period of time (e.g., one month). In another embodiment, loan fees can be computed on a day by day basis, so that if a user pays of an entire loan in two days, then that user will only pay the interest for the money borrowed for only two days. In this embodiment, the user can save on interest charges by paying off a loan more quickly.

From operation 200, the method proceeds to operation 201, wherein the user indicates the date and amount of the electronic funds transfer which is to come out of the user's credit line. For example, the user can schedule a transfer in the future for Apr. 1, 2020 for $1,000. Only on that date (typically at a particular time, such as the open of business (e.g., 8 am) on that particular day). If the user schedules a non-business day, then depending on the system the request may still be processed or it will be processed at the next business day.

In an embodiment, the user can also select an account that the transfer will go to. Typically, when the user applies for the credit line, the user will specify a default bank account owned by the user to which the funds from the credit line will be automatically transferred into. However, the user can specify multiple such accounts and upon the scheduling operation (operation 201), the user would specify which of the multiple accounts this particular transfer should be transferred into. In a further embodiment, the user is able to specify outside creditor accounts (e.g., rental company, electric company, etc.) so that the funds taken from the user's credit line will be automatically transferred to that creditor's account and would bypass the user's own banking accounts. If the loan transfer is sent to a creditor's account, then the user could specify an account number and/or optional identifier field which is also transmitted to the creditor so that the creditor can match up the payment with the user.

For example, if the user owns a store and knows that the rent for the store (e.g., $2,000) is due and wishes to pay this on Apr. 15, 2019, then the user can schedule this loan disbursement accordingly (by entering the date, amount, creditor information (including banking information, etc.), identifier (identifying the user), and any other relevant information that may be needed to make the transfer. In this way, the payment (actually a loan from the user's credit line) is paid directly to a party the user owes many too. In addition to the loaned funds being electronically transferred to a creditor, the funds can be mailed to the creditor via check (or other payment mechanism). Note that in this embodiment, the funds being used for the check are borrowed funds from the user's credit line and are not funds that are simply coming out of the user's liquid assets (e.g., a bank account).

Once all of the scheduled transfers(s) are entered, the system would store them and the user can exit the system in operation 202. Of course, the user is free to return to his/her account and cancel scheduled transfers or schedule additional ones. The system continuously monitors the current date/time and all outstanding scheduled dates (for all users of the system) so that it would act on every loan scheduled at the appropriate time. There is no limit to the number of scheduled loans a user can schedule. There is also no limit to the number of different users that can utilize the system.

Once the user logs out (in operation 202), the user would need to log back into his/her account in order to make additional changes/requests regarding his/her loans and transfers.

Note that if the user attempts to schedule a loan for more than the user's available credit, then this will not be permitted and the loan schedule will not be approved. Note that the user's available credit will be measured at the time the loan will be scheduled, taking into consideration other loans the user may have scheduled before that date. For example, if the user has a $6,000 credit line with $0 utilization on Jan. 1, 2020. On Jan. 1, 2020 the user then schedules a $2,000 loan on Feb. 1, 2020, a $3,000 loan on Feb. 15, 2020, and a $4,000 loan on Mar. 1, 2020. The system would reject the last loan because as of the March 2 date (disbursement date), the user would already have $5,000 in loans outstanding which means the user has $1,000 in credit remaining ($6,000 minus $5,000). Sine the Mar. 1, 2020 attempted loan (for $4,000) is greater than the amount of credit remaining ($1,000), then this loan schedule will be rejected. While it is possible the user may plan to (and does) make a payment to his/her account before Mar. 1, 2020 thereby freeing up enough of the available credit to make the Mar. 1, 2020 transfer for $4,000, the system does not know this and generally will not allow for loan transfers to exceed the outstanding available credit at a future point in time. In an alternative embodiment, the user's account can have an overdraft protection which would allow the user to take an outstanding loan amount which can exceed the user's credit line. The use of overdraft protection may incur the user additional interest charges and/or penalties by the lender.

FIG. 2B is a flowchart illustrating a method of scheduling a recurring loan transfer, according to an embodiment. FIG. 2B is similar to FIG. 2A but allows for a recurring scheduled loan transfer.

In operation 210, the user logs into the system. This is performed as described with respect to operation 201.

From operation 210, the method proceeds to operation 211, in which the user indicates information regarding the recurring loan transfer. This is performed similarly to operation 201 (which comprises the user specifying the amount, account the funds will be transferred to, etc.), but the user indicates that the transfer is recurring and indicates the recurring date (e.g., the 15^{th} of each month, etc.) and the quantity of such transfers before the recurring loan transfers automatically cease. For example, the user can schedule a loan transfer of $2,500 to be transferred on the third of every month (the starting month can also be specified). The user can indicate that this recurring loan transfer will continue until canceled by the user or the user can indicate a finite quantity of such recurring loan transfer (e.g., five) before the recurring loan transfer would automatically stop. As another example, the user can specify that a loan of $1,500 will be automatically transferred to his/her account on the 15^{th} of every month from Jun. 15, 2019 to Dec. 15, 2020 upon which the automatic loan disbursements will stop.

In this way, if the user knows he has to write a rent check on the fifth of each month, the user can schedule a recurring loan transfer to be transferred on the third of each month (allowing two days for the transfer) in which when the user writes the rent check the user's bank account will be ensured to have the minimum amount of funds required to cover the rent check. Note that this would be preferable to the user taking a loan earlier than necessary because that might incur additional interest charges. In addition, while the user could initiate such a loan manually on the days needed, this would be inconvenient for the user and if the user forgot to initiate the loan then the user may not have sufficient funds to cover his/her expenses coming out of that account.

Note that in operation 211, instead of scheduling a recurring loan the user can also cancel a recurring loan that is already scheduled. Once canceled, no further automatic payments would be initiated. Of course, the user can again reschedule another recurring loan if he/she wishes.

From operation 211, the method proceeds to operation 212, in which the user logs out of the system/account. This is performed similarly to operation 202. Note that the user does need to be logged into his/her account in order for the scheduled loans to be processed, those would be processed automatically on the respective date(s).

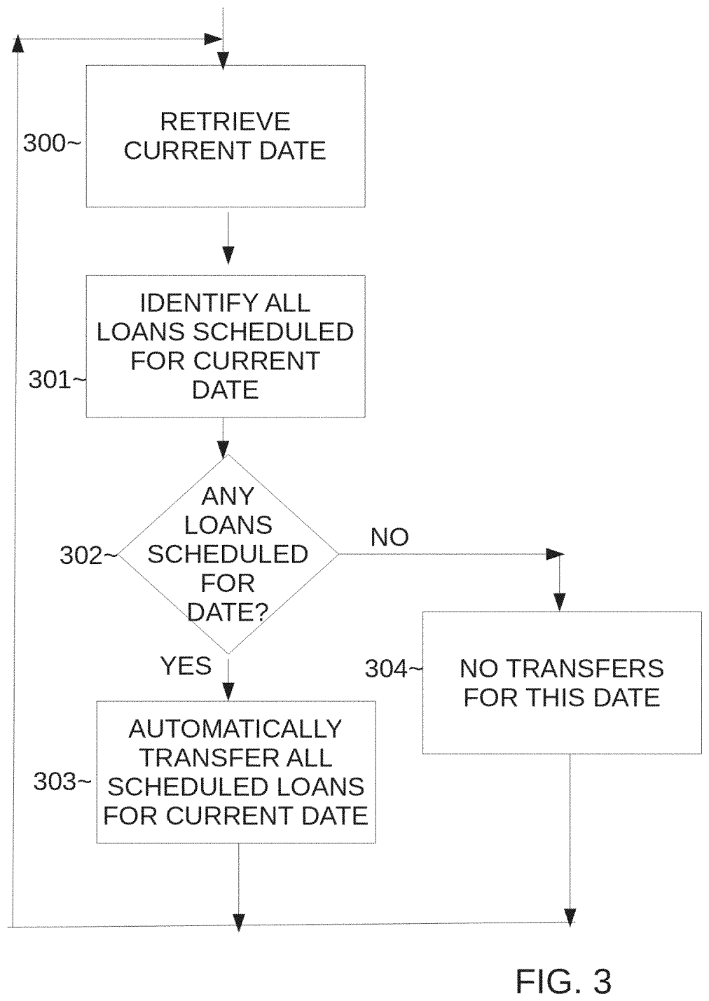

FIG. 3 is a flowchart illustrating a method of automatically processing scheduled loans, according to an embodiment. Note that FIG. 3 would be continuously running, or would be implemented once per day (e.g., at a particular time each day (or alternatively only on business days) such as 6 am). FIG. 3 is intended to be implemented with the method illustrated in FIG. 2B (scheduling recurring scheduled loans).

In operation 300, the current date is retrieved electronically.

From operation 300, the method proceeds to operation 301, which identifies all loans scheduled to be disbursed (transferred for that day). This can be done by querying the database that all scheduled loans are stored in and retrieving those scheduled for disbursement on the current day.

From operation 301, the method proceeds to operation 302, which determines if there are any scheduled loans to be transferred for the current date (with are identified in operation 301). If there are no loans to process for this day, then the method proceeds to operation 304, in which there are no transfers for this date. The method continues back at operation 300 on the next day (or can continuously run) so all days have their scheduled loans processed.

From operation 302, if there are any scheduled loans to be transferred for the current day, then the method proceeds to operation 303, which automatically transfers (initiates) all of the scheduled loans which are to be scheduled for the current day.

Note that if a user's available credit is not at least the amount of the scheduled loan, then the loan would typically not be processed and the respective user would be informed as such.

Each user's available credit out of the user's credit line will reflect the deduction of the amount of the loan. If the transfer is to an outside creditor of the user, then the transfer may also contain identifier field(s) identifying the user's account number with the creditor (and optionally his/her name, etc.) so the creditor would successfully match the payment up to the user who requested the transfer so the user's account with the credit will reflect the payment.

Note that before a scheduled transfer is initiated, the lender may optionally re-evaluate the user's credit worthiness (such as what was done in operation 101) to ensure that the user is a good credit risk. In an embodiment, any loan transfer that is scheduled more than a predetermined number of days in the future (e.g., 30 days) would be subject to a credit re-evaluation before such loan transfer is initiated. If the user does not pass such credit re-evaluation, then the system would inform the user that the scheduled loan transfer will not be initiated due to the user's poor credit evaluation.

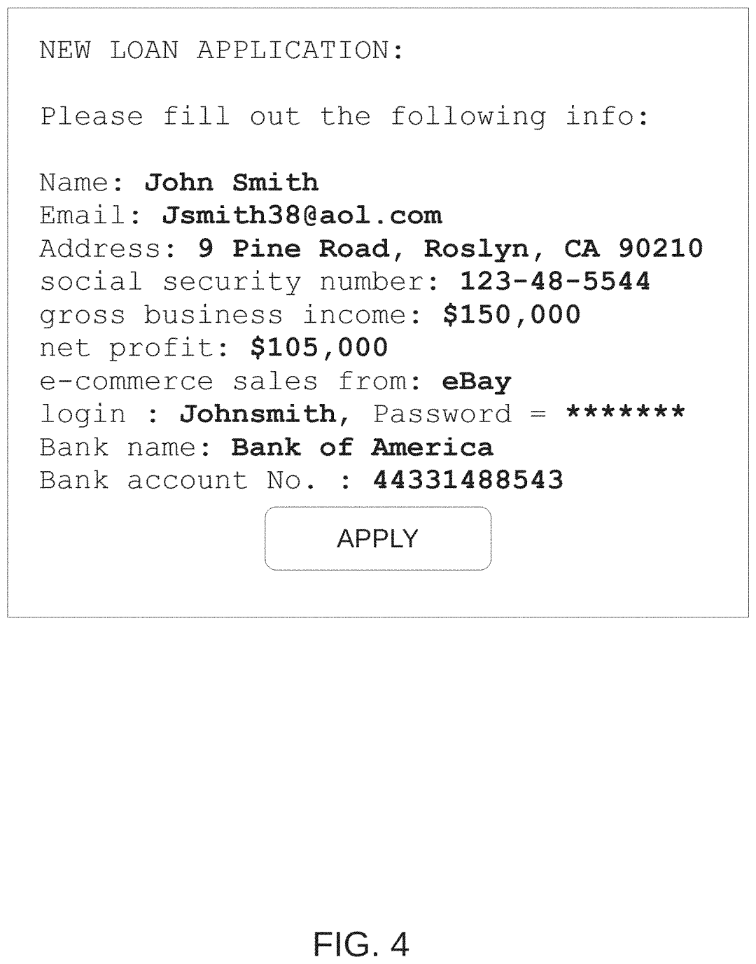

FIG. 4 is a drawing illustrating an input window inputting a loan application from a user, according to an embodiment.

In operation 100, the user would fill out an application in order to apply for a loan (the information entered shown in bold). FIG. 4 illustrates one sample application window in which the user can enter such information. Of course, the information illustrated is just one example, a lender could ask for any other information the lender feels is relevant. Once the user has completed the form, the user can press the “apply” button to have his/her application evaluated.

Note that it may not be necessary for the user to apply for a loan with the lender. The user may already have applied for a loan or other financial product at an earlier time.

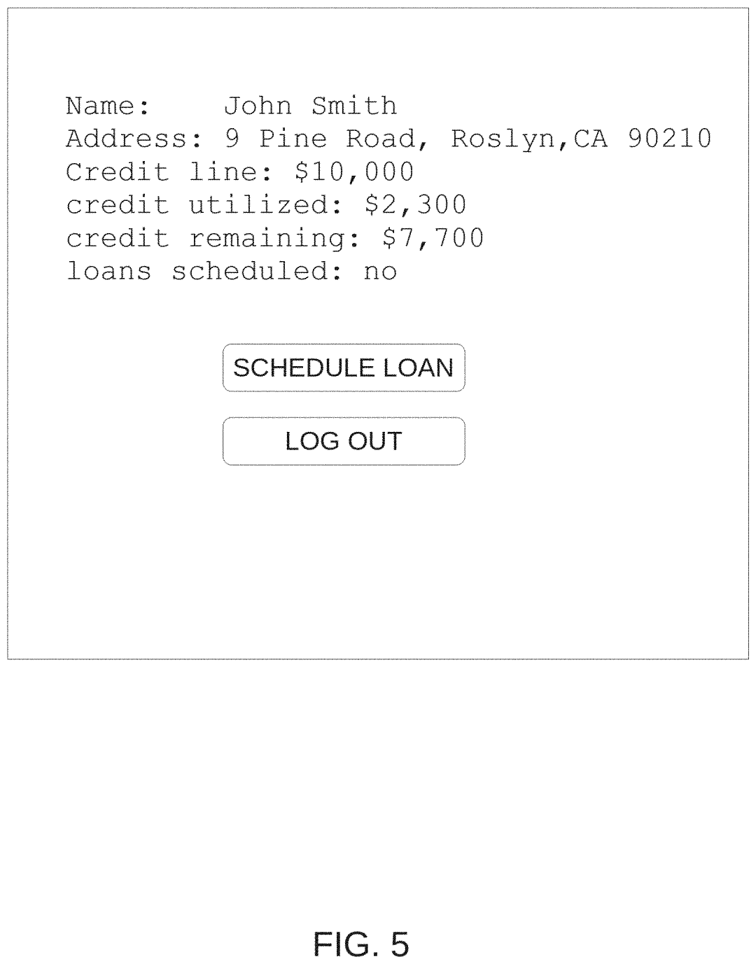

FIG. 5 is a drawing illustrating an input window displaying account information, according to an embodiment.

When the user logs into his/her account, the user will be presented with an account information window/screen. The information displayed can include the amount of the credit line, the credit currently utilized (borrowed), how much credit is remaining (the credit line minus the credit utilized), and a listing of all loans currently scheduled. Of course, the account information window can display any other relevant information as well. The user is free to update any information the system has about him/her at any time (e.g., add additional bank accounts that loans can be transferred into, etc.)

From this screen, the user can log out (by pressing the appropriate button) or schedule a loan (by pressing the appropriate button).

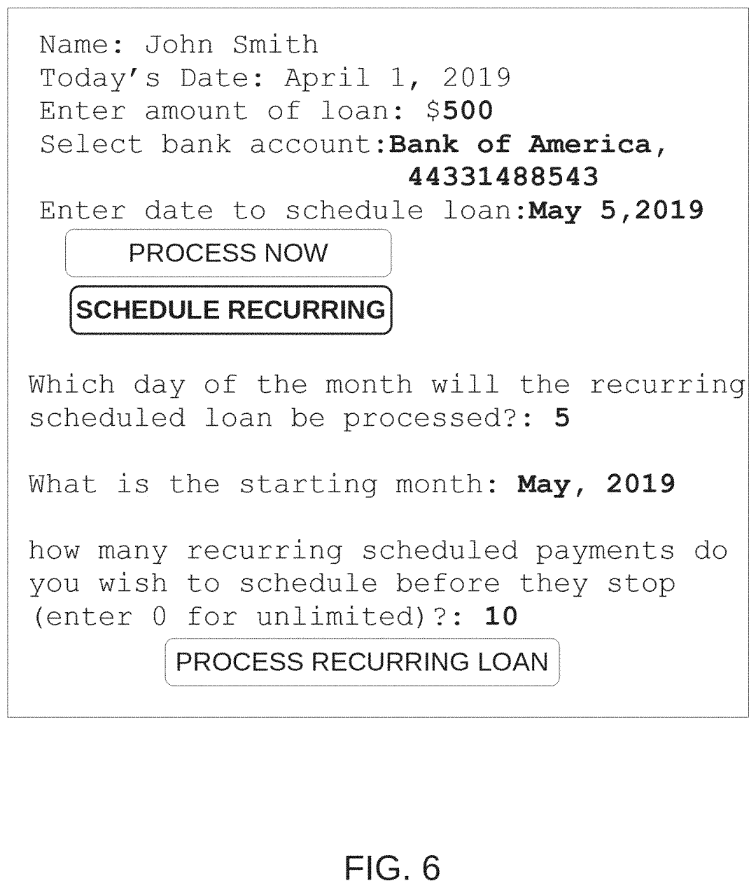

FIG. 6 is a drawing illustrating an input window initiated a scheduled loan including a recurring scheduled loan, according to an embodiment.

If the user desires to schedule a loan, the user would enter information such as the amount of the loan, the bank account the loan will be transferred into (this can be selected from a plurality of pre-populated entries since this information may have already been entered during the application process), the date of the scheduled loan, etc. If the user wishes to schedule this loan, the user can press the “process now” button.

Note that user can also indicate his/her desire to schedule a recurring loan. In an embodiment, the user can press the “schedule recurring loan” button which would bring up additional questions under the “schedule recurring loan” button as shown in FIG. 6. This queries the user for information on how to schedule the recurring loan, such as the dates, quantity of transfers, etc. The amount and bank account used can be the same from above.

Note that FIGS. 4-6 illustrate one example of a graphical user interface, but it can be appreciated that any other mechanisms to input data and display information can be used, and the ones presented herein are merely examples. It is further noted that the actual fields of data used herein are examples and additional data can be inputted/outputted as well (e.g., sex of user, age of user, etc.)

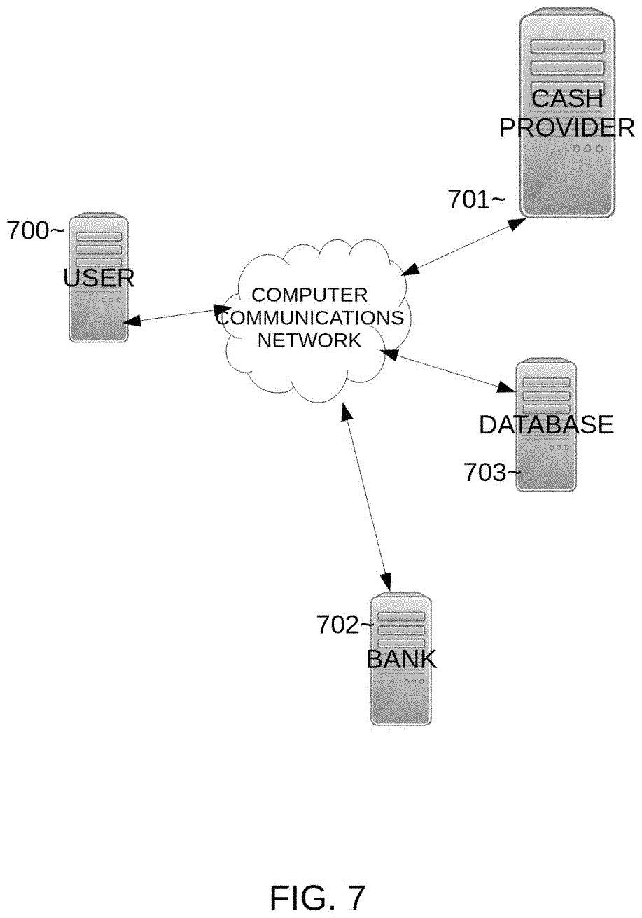

FIG. 7 is a network drawing illustrating components on the computer communications network, according to an embodiment.

A user 700 (there would be many such users, from 1 to 10,000,000 or more) applies for a loan/credit line through the cash provider (lender) 701 server (typically by visiting a web site hosted or maintained by the cash provider 701 using a web browser). The user 700 can use any remote computing device, such as a cell phone, laptop, table, personal computer, etc. The cash provider 701 (operated/controlled by the lender itself) would then process the application (as described herein) and issue a decision whether to approve the application or not. If the application is approved, then at the time/day scheduled by the user, the cash provider 701 would then initiate an electronic transfer of funds to the user 700 directly from the cash provider's bank account into the user's bank account (provided during the application process). A database 703 is used by the cash provider 701 and can be accessible to the cash provider 701 via the internet or a local computer communications network (e.g., LAN, etc.) The database 703 can store all data needed by the cash provider and can include, for example, all of the historical data obtained about each user's financial transactions. The database 703 can also store any other information described herein or needed by the cash provider 701. All of the data stored by the database 703 can be stored and retrieved utilizing a relational database, utilizing SQL or any other such protocol.

A bank server 702 is operated by a bank that the user has an account with, and a loan distributed by the cash provider 701 can be electronically transferred to an account at the bank which is administered by the bank server 702.

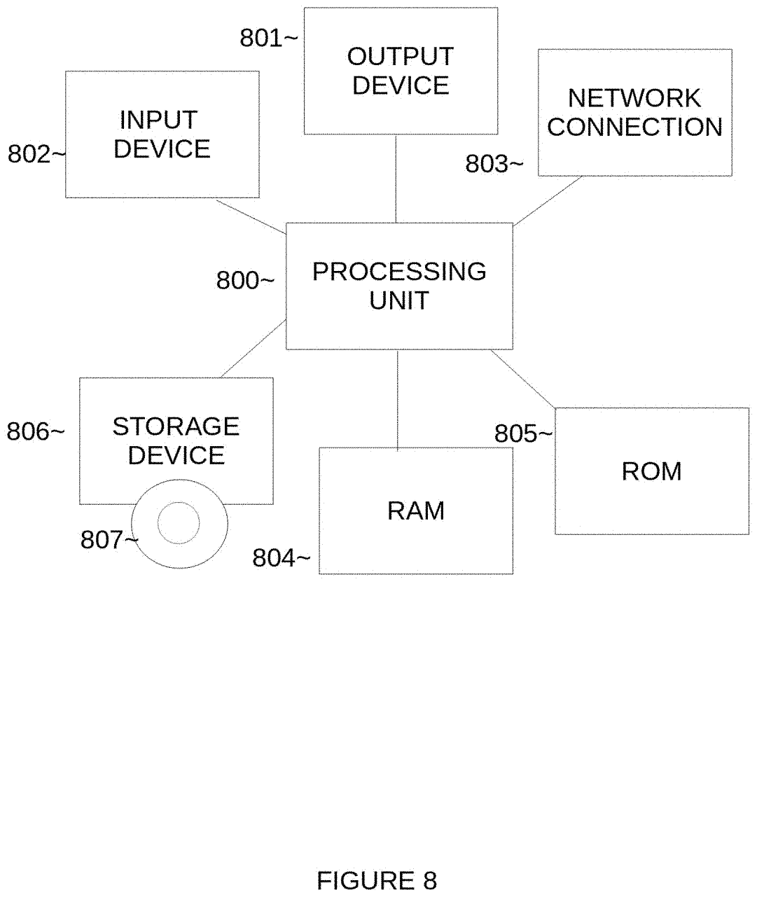

FIG. 8 is a block diagram illustrating an example of computer hardware which can be used to implement any computer utilized herein, according to an embodiment. The computer can also be any computing device, such as a cellular phone, tablet, server, database, personal computer, etc.

A processing unit 800 (such as a microprocessor and any associated components) is connected to an output device 801 (such as an LCD monitor, touch screen, CRT, etc.) which is used to display to the player any aspect/output/state of the method, and an input device 802 (e.g., buttons, a touch screen, a keyboard, mouse, etc.) which can be used to input from the player any decision/input made by the player. All methods described herein can be performed by the processing unit 600 by loading and executing respective instructions. Multiple such processing units can also work in collaboration with each other (in a same or different physical location). The processing unit 800 can also be connected to a network connection 803, which can connect the processing unit 800 to a computer communications network such as the Internet, a LAN, WAN, etc. The processing unit 600 is also connected to a RAM 804 and a ROM 805. The processing unit 800 is also connected to a storage device 806 which can be a disk drive, DVD-drive, CD-ROM drive, flash memory, etc. A non-transitory computer readable storage medium 807 (e.g., hard disk, CD-ROM, etc.), can store a program which can control the electronic device (via the processing unit 800) to perform any of the methods described herein and can be read by the storage device 806. A program (e.g., an application or “app”) can be executed by the processing unit 800 in order to perform any of the methods/embodiments described herein. Such application can be downloaded from the internet by the processing unit 800 via an online store (e.g., “app store” or “play store”). Any computer (e.g. the cash provider server, etc.) described herein can be utilized to implement the methods described herein, working individually or in conjunction with other computers.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

Any description of a component or embodiment herein also includes hardware, software, and configurations which already exist in the prior art and may be necessary to the operation of such component(s) or embodiment(s).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
executing computer readable instructions on at least one processor, the at least one processor performing:
receiving from a user an application for a loan of cash funds;
evaluating and approving the application and extending the user a credit line;
receiving from the user a request for a scheduled loan on a particular date from the credit line for an amount;
automatically initiating transfer of funds when the particular date arrives for the amount of the scheduled loan from the credit line to a bank account associated with the user, the transfer of funds being a loan to which the user will owe interest on.

2. The method as recited in claim 1, wherein the request from the user for the scheduled loan comprises requesting a recurring loan with payment dates.

3. The method as recited in claim 2, further comprising automatically initiating further transfers of funds from the credit line for the amount of the scheduled loan to a bank associated with the user when the payments dates arrive.

4. The method as recited in claim 1, further comprising, before the initiating transfer of funds, re-evaluating a credit score of the user.

5. The method as recited in claim 4, wherein the initiating transfer of funds is approved based on the user having passed the re-evaluating.

6. The method as recited in claim 4, wherein the executing computer readable instructions prevents the initiating transfer of funds when the user did not pass the re-evaluating.

7. The method as recited in claim 1, further comprising, after receiving from the user the request for the scheduled loan, determining whether an available credit of the user on the particular date is at least equal to the amount.

8. The method as recited in claim 7, wherein the request is approved based on the determining having determined that the available credit of the user on the particular date is at least equal to the amount.

9. The method as recited in claim 7, wherein the executing computer readable instructions denies the request when the available credit of the user on the particular date is lower than the amount.

10. An apparatus, comprising:
an internet connection;
a server connected to the internet connection, the server configured to read computer readable instructions stored on a non-transitory computer readable storage medium, the computer readable instructions programmed to cause performance of the following operations:
receive from a user an application for a loan of cash funds;
evaluate the application, wherein if the application is approved then the user is extended a credit line;
receive from the user a request for a scheduled loan on a particular date from the credit line for an amount;
automatically initiate transfer of funds when the particular date arrives for the amount of the scheduled loan from the credit line to a bank account associated with the user, the transfer of funds being a loan to which the user will owe interest on.

11. The apparatus as recited in claim 10, wherein the computer readable instructions are further programmed such that the request from the user for the scheduled loan comprises the user having an option to request a recurring loan with payment dates.

12. The apparatus as recited in claim 11, wherein the computer readable instructions are further programmed to automatically initiate further transfers of funds from the credit line for the amount of the scheduled loan to a bank associated with the user when the payments dates arrive.

13. The apparatus as recited in claim 10, wherein the computer readable instructions are further programmed to, before the initiate transfer of funds, re-evaluate a credit score of the user, wherein the initate transfer of funds is processed if the user passed the re-evaluation and the initiate transfer of funds is prevented if the user did not pass the re-evaluation.

14. The apparatus as recited in claim 10, wherein the computer readable instructions are further programmed to, after the receive from the user the request for the scheduled loan and before the initiate transfer of funds, determine whether an available credit of the user on the particular date is at least equal to the amount, wherein the request is approved if the available credit of the user on the particular date is at least equal to the amount and the initiate transfer of funds is performed, and the request is not approved and the initiate transfer of funds is not performed when the available credit of the user on the particular date is not at least equal to the amount.
